(19) United States
(12) Patent Application Publication
(10) Pub. No.: US 2025/0004854 A1
(43) Pub. Date: Jan. 2, 2025

(54) PRIORITIZING CURATION TARGETS FOR DATA CURATION BASED ON RESOURCE PROFICIENCY

(71) Applicant: Dell Products L.P., Round Rock, TX (US)

(72) Inventors: OFIR EZRIELEV, Beer Sheva (IL); HANNA YEHUDA, Acton, MA (US); KRISTEN JEANNE WALSH, Austin, TX (US)

(21) Appl. No.: 18/343,937

(22) Filed: Jun. 29, 2023

(51) Int. Cl. G06F 9/50

(52) U.S. Cl. CPC G06F 9/5077; G06F 9/5038

(57) ABSTRACT

Methods and systems for curating data by a data manager are disclosed. Data collected from various data sources may be curated before being provided to downstream consumers that may rely on the trustworthiness of the curated data in order to provide computer-implemented services. During data curation, data curation resources may be assigned to curate (e.g., improve the trustworthiness of) the data. However, the data curation resources (e.g., data curators) may have differing abilities (e.g., levels of efficiency) for curating different types of data; therefore, the efficiency of the data curation process may depend on the strengths and/or weaknesses of the data curation resource assigned to curate a data type. Inefficient data curation may lead to an unavailability of trustworthy data for downstream consumers; thus, to optimize the allocation of data curation resources, the data type may be matched with the data curation resource(s) likely to curate the data most efficiently.

### FIELD

Embodiments disclosed herein relate generally to data management. More particularly, embodiments disclosed herein relate to systems and methods for data curation.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating a process for obtaining a data curation resource profile in accordance with an embodiment.

FIG. 2B shows a data flow diagram illustrating a process for obtaining a data curation assignment in accordance with an embodiment.

FIG. 3A shows a flow diagram illustrating a method for obtaining a data curation resource profile in accordance with an embodiment.

FIG. 3B shows a flow diagram illustrating a method for curating data by a data manager in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for curating data by a data manager (e.g., prior to addition to a data repository). Data curation may include obtaining data from various data sources and/or storing the data in one or more data repositories. The data repository may be managed by a data manager that may also manage the data curation process. Data curation may include processes such as collecting, organizing (e.g., indexing, labeling, cataloging, etc.), preserving, and/or maintaining data for use by consumers. For example, downstream consumers of curated data may rely on raw and/or processed data being made accessible in order to provide computer-implemented services.

Data curation may improve the value of data collected from various data sources (e.g., that may provide inconsistent and/or disorganized datasets). For example, data curation may remediate inaccurate data (e.g., data that includes incorrect information, knowledge gaps, etc.). Inaccurate data may be untrustworthy (e.g., biased, unreliable, etc.) for use in downstream applications (e.g., downstream consumption that may facilitate computer-implemented services). Thus, the data curation process may increase the value of the collected data by improving its usability, accessibility, and/or trustworthiness.

The data curation process may utilize data curation resources (e.g., one or more data curators using one or more data processing systems) to generate curated data from data collected from various sources and/or read from various data repositories. However, different data curation resources may possess varying levels of proficiency in curating different types of data. The level of proficiency of a data curation resource may indicate the ability of the data curation resource to perform a data curation process accurately, efficiently, and/or to generate curated data that meets or exceeds a desired level of quality. For example, a data curator may be more proficient in curating a first type of data (e.g., due to knowledge of a particular language) when compared to curating a second type of data (e.g., for which the data curator may not possess specialized knowledge relating to a particular subject of the second type of data). Thus, the efficiency of the data curation process and/or the quality of the resulting curated data may be affected based on the data curation resource(s) used to perform the data curation process.

For example, if the data curation resource assigned to curate a type of data is not as proficient in curating the type of data as an alternative data curation resource, then the data curation resources may be inefficiently utilized. The inefficient use of data curation resources may result in (i) the unavailability of curated data for downstream use (e.g., due to missed deadlines for data curation completion), (ii) a potential reduction in quality of available curated data (e.g., the curated data may not comply with quality guidelines and/or other schemas for downstream use), and/or (iii) increased costs associated with data curation. The unavailability of curated data and/or the consumption of untrustworthy (e.g., reduced quality) curated data may pose a risk to downstream consumers and/or the computer-implemented services facilitated by the downstream consumers (e.g., delays and/or stoppages in the computer-implemented services).

Therefore, to prevent and/or reduce inefficient use of data curation resources, the data curation resource that is most likely to curate a portion of the data more efficiently than other data curation resources (e.g., based on a rank ordering of data curation resources) may be enlisted for performing a data curation process for the portion of the data. To identify the data curation resource that is most likely to curate the portion of the data more efficiently than the other data curation resources, characteristics of the curation targets and/or characteristics of each of the data curation resources may be analyzed and/or compared in order to find a best match (e.g., between a data curation resource and a curation target). For example, data of a particular data type (e.g., described by its data characteristics) may be matched with a data curation resource that is historically most proficient in performing data curation for the particular data type when compared to other available curation resources. The data type may be defined by any number and/or combination of data characteristics. For example, a first data type may include textual data describing wildlife, a second data type may include images of the wildlife, and a third data type may include images of metropolitan areas (e.g., of smart cities).

By doing so, embodiments disclosed herein may provide a system for optimizing the allocation of data curation resources (e.g., used to perform data curation for curation targets). By matching data curation targets with the data curation resource(s) most likely to be more efficient (e.g., than other data curation resources) for curating the curation targets, the efficiency of the data curation process and/or quality of the curated data may be improved. By doing so, the likelihood of providing the downstream consumers with uninterrupted and/or reliable access to trustworthy curated data may be increased, (e.g., especially when data curation resources may be limited).

By doing so, an improved computing device and/or distributed system may be obtained. The improved device and/or system may be more likely to be able to provide the desired computer-implemented services.

In an embodiment, a method for curating data by a data manager is provided. The method may include: performing a data curation matching process to identify a match between a portion of data and a data curation resource, the match being identified based on a likelihood that the data curation resource will curate the portion of the data more efficiently than other data curation resources; obtaining, based at least in part on the match, an assignment for data curation; and, performing a data curation process based on the assignment to obtain a curated portion of data.

The method may also include, prior to performing the data curation matching process: obtaining historical data curation resource performance data and performing an analysis of the historical data curation resource performance data to obtain a data curation resource profile.

The data curation resource profile may be used in the data curation matching process to identify the likelihood. The data curation resource profile may specify levels of proficiency of one of the data curation resources to curate different types of data.

The historical data curation resource performance data my include durations of time required by one of the data curation resources to curate instances of the different types of the data. The historical data curation resource performance data may include error rates for the different types of the data in curated instances of the different types of the data as curated by the one of the data curation resources.

Performing the data curation matching process may include rank ordering the data curation resources to curate the portion of the data to identify the data curation resource.

Rank ordering the data curation resources may include: obtaining a data curation resource profile for each of the data curation resources; obtaining a data type for the portion of the data; obtaining a fitness value for each of the data curation resources using a corresponding data curation profile and the data type; and, defining the rank ordering using the fitness value for each of the data curation resources.

The data curation resource profile for each of the data curation resources may include a level of proficiency for curating a type of the portion of the data. The level of proficiency may be based on at least one selected from a group consisting of a data curation rate for the type of the portion of the data, an error rate for the type of the portion of the data, and a quality score for the type of the portion of the data.

The method may further include providing a computer-implemented service using the curated portion of the data.

A non-transitory media may include instructions that when executed by a processor cause the computer-implemented method to be performed.

A data processing system may include the non-transitory media and a processor, and may perform the computer-implemented method when the computer instructions are executed by the processor.

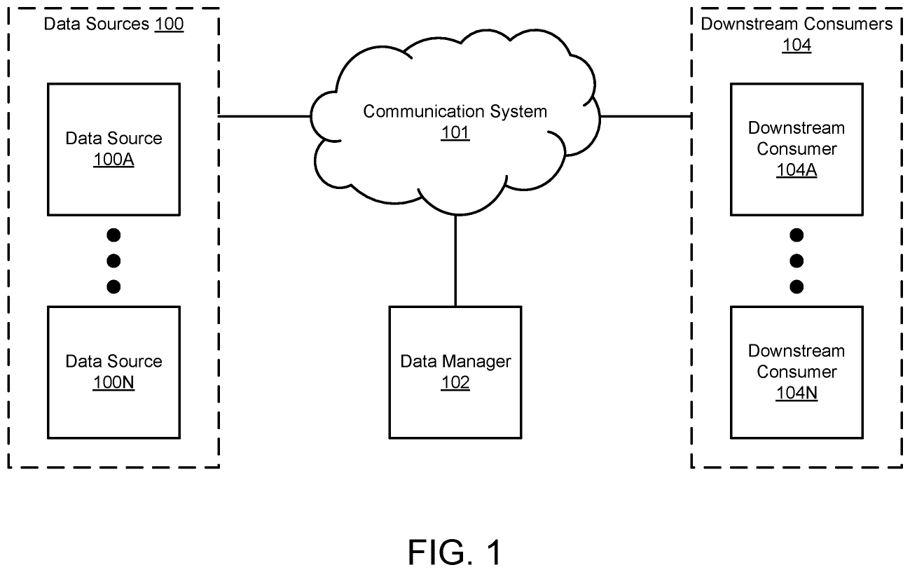

Turning to FIG. 1, a block diagram illustrating a system in accordance with an embodiment is shown. The system shown in FIG. 1 may provide computer-implemented services utilizing data obtained from any number of data sources and managed by a data manager prior to performing the computer-implemented services. The computer-implemented services may include any type and quantity of computer-implemented services. For example, the computer-implemented services may include monitoring services (e.g., of locations), communication services, and/or any other type of computer-implemented services.

The computer-implemented services may be performed, in part, by using artificial intelligence models (e.g., inference models). The inference models may, for example, be implemented with artificial neural networks, decision tress, regression analysis, and/or any other type of model usable for learning purposes. For example, data obtained from data sources 100 may be used as training data (e.g., used to train the inference models to perform the computer-implemented services), and/or as ingest data (e.g., used as input to the trained inference models in order to perform the computer-implemented services).

To facilitate the computer-implemented services, the system may include data sources 100. Data sources 100 may include any number of data sources. For example, data sources 100 may include one data source (e.g., data source 100A) or multiple data sources (e.g., 100A-100N). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may include any number of temperature sensors positioned in an environment to collect temperature measurements according to a data collection schedule. Data sources 100 may be associated with a data pipeline and, therefore, may collect the temperature measurements, may perform processes to sort, organize, format, and/or otherwise prepare the data for future processing in the data pipeline, and/or may provide the data to other data processing systems in the data pipeline (e.g., via one or more application programming interfaces (APIs)).

Data sources 100 may provide data to data manager 102. Data manager 102 may include any number of data processing systems including hardware and/or software components configured to facilitate performance of the computer-implemented services. Data manager 102 may include a database (e.g., a data lake, a data warehouse, etc.) to store data obtained from data sources 100 (and/or other entities throughout a distributed environment).

Data manager 102 may obtain data (e.g., from data sources 100), process the data (e.g., clean the data, transform the data, extract values from the data, etc.), store the data, and/or may provide the data to other entities (e.g., downstream consumer 104) as part of facilitating the computer-implemented services. Continuing with the above example, data manager 102 may obtain the temperature measurements from data sources 100 as part of the data pipeline. Data manager 102 may obtain the temperature measurements via a request through an API and/or via other methods.

The process of obtaining, organizing and/or integrating data collected from various data sources by data manager 102 may be referred to as data curation. Data curation may be performed by a data processing system of data manager 102 and/or a data processing system independent of data manager 102 (e.g., a third party).

Data curation may include any process that may improve the downstream usability of the collected data. For example, data curation may include processes and/or methods to remediate incomplete, irrelevant, and/or inaccurate (e.g., misrepresented) data among the collected data. The results of data curation processes (e.g., curated data) may be stored and/or provided for downstream use. For example, curated data may be provided directly to downstream consumers (e.g., for statistical analysis), and/or as input to downstream processes (e.g., as training data and/or ingest data for inference modeling).

For example, data manager 102 may curate a volume of image data by labeling each image of the volume of image data. (e.g., labeling with strings of text that describe content found in each image). As part of the data curation process, data manager 102 may also identify existing errors and/or omissions of existing labels and may correct the identified labels before storing the curated image data temporarily and/or permanently in a data lake or other storage architecture. Following curating the image data, data manager 102 may provide the image data and the corresponding labels to other entities for use in performing the computer-implemented services.

Data managed by data manager 102 (e.g., stored in a data repository managed by data manager 102, obtained directly from internet of things (IoT) devices managed by data manager 102, etc.) may be provided to downstream consumers 104. Downstream consumers 104 may utilize the data from data sources 100 and/or data manager 102 to provide all, or a portion of, the computer-implemented services. For example, downstream consumers 104 may provide computer-implemented services to users of downstream consumers 104 and/or other computing devices operably connected to downstream consumers 104.

Downstream consumers 104 may include any number of downstream consumers (e.g., 104A-104N). For example, downstream consumers 104 may include one downstream consumer (e.g., 104A) or multiple downstream consumers (e.g., 104A-104N) that may individually and/or cooperatively provide the computer-implemented services.

All, or a portion, of downstream consumers 104 may provide (and/or participate in and/or support the) computer-implemented services to various computing devices operably connected to downstream consumers 104. Different downstream consumers may provide similar and/or different computer-implemented services.

Continuing with the above example, downstream consumers 104 may utilize the temperature data via data manager 102 as input data for climate models. Specifically, downstream consumers 104 may utilize the temperature data to simulate future temperature conditions in various environments over time (e.g., to predict weather patterns, climate change, etc.).

However, the quality and/or availability of computer-implemented services may be affected, at least in part, by the quality and/or availability of curated data. For example, uncurated data may be untrustworthy (e.g., due to poor quality, missing and/or incorrect data) and may negatively affect the computer-implemented services provided to and/or by downstream consumers. To avoid potential negative effects of uncurated data on the computer-implemented services, the downstream consumers may prefer to rely on curated data; however, if adequate volumes of curated data are unavailable, the associated computer-implemented services may be slowed, and/or suspended (e.g., when data is being collected and/or curated to be used as ingest data for an inference model that provides the computer-implemented services via inference generation).

The quality and/or availability of curated data may depend on the quantity, availability, and/or proficiency of the data curation resources (e.g., data curators, computing resources, etc.) used to perform the data curation process. The proficiency of a data curation resource may refer to the ability of the data curation resource to perform the data curation process in a timely and/or efficient manner, and/or at the desired level of quality (e.g., based on historical error rates and/or durations of time required to curate types of data).

For example, the large volumes of data collected from data sources 100 may include curation targets (e.g., identified based on data type, intended use of data, etc.). The curation targets may include portions of the data, such as one or more data points having one or more fields and/or one or more fields of the one or more data points. A curation target may, for example, refer to a value (e.g., of a field), a data point (e.g., including multiple fields), and/or groups of data points (e.g., portions of data). If the data curation resources are limited and/or poorly allocated, the desired amount of curation targets may not be curated (e.g., to a desired level of quality and/or within a target period of time), which may result in unavailable and/or reduced quality curated data.

For example, a data curator may be assigned portions of the large volumes of data (e.g., curation targets) to curate. The data curator may not have the ability (e.g., based on the proficiency of the data curator in curating similar curation targets, the availability of the data curator, etc.) to perform the data curation process in the allotted time frame, which may result in (i) reduced quality curated data (e.g., improperly and/or inconsistently labeled data), (ii) uncurated portions of data (e.g., untrustworthy portions of data) persisting in the data, and/or (iii) an unavailability of the desired volumes of curated data (e.g., for downstream use).

Continuing with the above example regarding climate models, if insufficient volumes of the desired quality of curated data are available (e.g., leading to biased temperature samples) and/or if uncurated data (e.g., that may include irrelevant, missing, and/or incorrect temperature data) is introduced in climate modeling, then the resulting climate models may be skewed. Further, the skewed climate models may negatively impact the simulations, which may prevent downstream consumers 104 from providing the desired computer-implemented services.

Thus, to increase the likelihood of providing trustworthy curated data to downstream consumers, the use of data curation resources may be optimized (e.g., based on their proficiency). To do so, portions of data available for curation (e.g., curation targets of data collected from data sources 100) may be matched with an available data curation resource. The matched data curation resource may be more likely to curate the matched portions of data more efficiently than other data curation resources, based on characteristics of the portions of data and characteristics of the data curation resource. For example, a data curation resource may be matched with curation targets similar to those that the data curation resource has historically been more proficient in curating (e.g., when compared to the proficiency of other data curation resources in curating similar curation targets). The optimization of data curation resource use may prevent and/or mitigate the potential negative effects of unavailable and/or reduced quality curated data on downstream computer-implemented services.

In general, embodiments disclosed herein may provide methods, systems, and/or devices for curating data using the most efficient data curation resource match for the data. The data curation methods may (i) analyze historical data curation resource performance data (e.g., to obtain data curation resource profiles for each data curation resource), (ii) analyze portions of the data intended for curation (e.g., to obtain a data type of the curation target), (iii) identify a match between the portions of the data and one or more data curation resources (e.g., based on the data curation resource profile and the data type), and/or, (iii) perform a data curation process for the portions of the data using the data curation resource(s) (e.g., of the match) in order to obtain a curated portion of data.

By doing so, the system may be more likely to utilize data curation resources efficiently and/or more likely to be able to provide trustworthy data to downstream consumers in a timely manner that may facilitate the timely performance of the desired computer-implemented services.

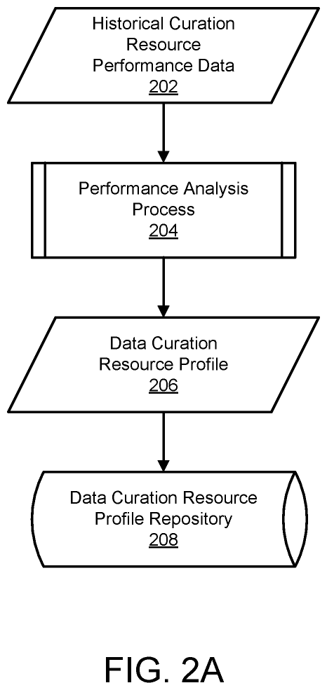

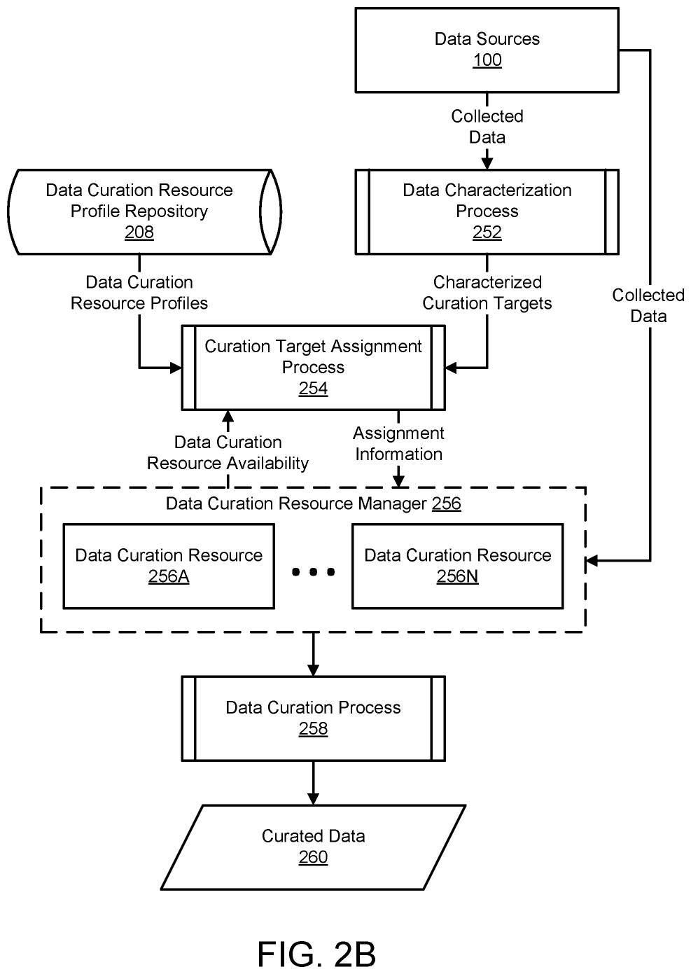

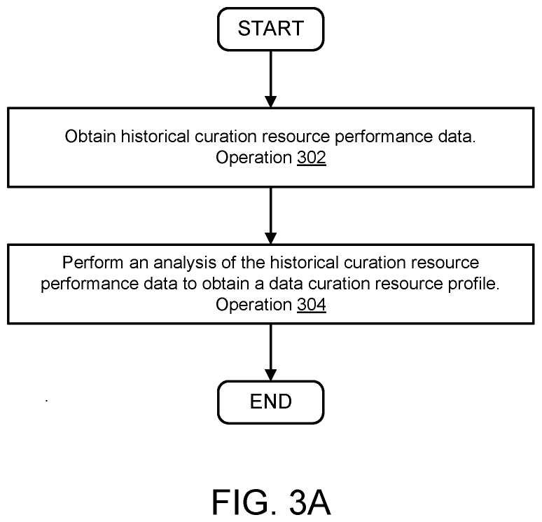

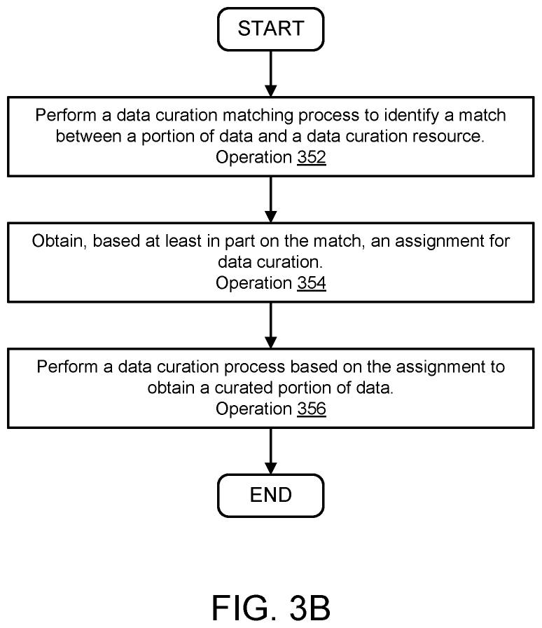

When performing its functionality, data sources 100, data manager 102, and/or downstream consumers 104 may perform all, or a portion, of the methods and/or actions shown in FIGS. 2A-3B.

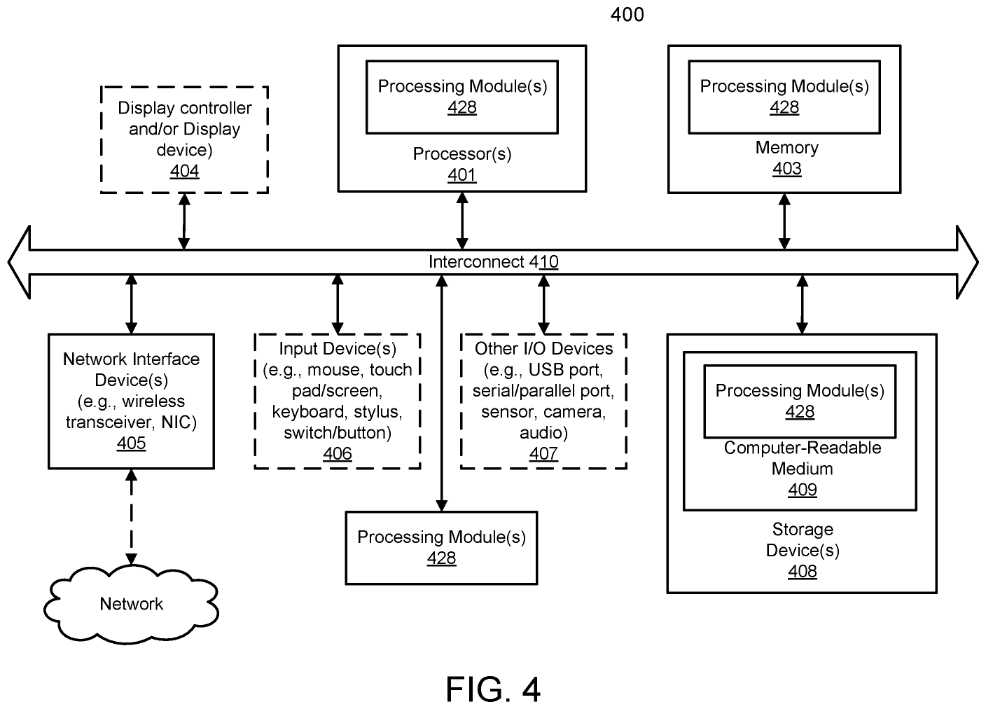

Data sources 100, data manager 102, and/or downstream consumers 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data sources 100, data manager 102, and/or downstream consumers 104 are implemented using an internet of things (IoT) device, which may include a computing device. The IoT device may operate in accordance with a communication model and/or management model known to data sources 100, data manager 102, downstream consumers 104, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

While the above example relates to climate models, it will be appreciated that data may be collected and/or stored in data repositories in order to provide other types of computer-implemented services without departing from embodiments disclosed herein.

The system described in FIG. 1 may be used to match data curation resources with curation targets (e.g., of data intended for data curation) based on the likelihood of increasing the efficiency of (at least one part of) the data curation process. This optimized use of data curation resources may reduce and/or prevent potential negative effects of unavailable and/or reduced quality curated data in the downstream use of the data. The processes shown in FIGS. 2A-2B may be performed by any entity shown in the system of FIG. 1 (e.g., a data source similar to data source 100A, a data manager similar to data manager 102, a downstream consumer similar to downstream consumer 104A, etc.) and/or another entity without departing from embodiments disclosed herein.

Turning to FIG. 2A, a data flow diagram is shown in accordance with an embodiment. The data flow diagram may illustrate a process for obtaining a data curation resource profile in a system similar to that of FIG. 1. As discussed with respect to FIG. 1, different data curation resources may possess different levels of proficiency in curating different types of data (e.g., types of curation targets). To determine the level of proficiency of a data curation resource (e.g., a data curator) for curating a specific type of data, the historical data curation performance of the data curation resource (e.g., used to curate the specific type of data) may be analyzed.

Thus, historical data curation resource performance data 202 may be analyzed by performance analysis process 204. Historical data curation resource performance data 202 may include information regarding one or more data curation resources previously used to perform data curation for one or more data types. For more information regarding data types, refer to the discussion of FIG. 2B.

Historical data curation resource performance data 202 may include (i) durations of time required by a data curation resource to curate instances (e.g., curation targets) of the data type, (ii) error rates for the different curated data types (e.g., as curated by the data curation resources), (iii) information regarding the impact and/or use of the historically curated data (e.g., feedback scores from downstream consumers), and/or (iv) other information that may be used to measure the historical performance of the data curation resource.

Performance analysis process 204 may include analyzing (e.g., using one or more methods of statistical analysis) historical data curation resource performance data 202 of a data curation resource in order to obtain data curation resource profile 206. For example, performance analysis process 204 may include analyzing historical data curation resource performance data 202 to obtain data curation resource characteristics of each data curation resource for a data type (e.g., the data curation resource having (historically) performed data curation for data of the data type). One or more data curation resource characteristics (e.g., for one or more data types) may be included in a data curation resource profile associated with a data curation resource (e.g., data curation resource profile 206).

Data curation resource profile 206 may include (i) a data curation resource identifier (e.g., a data curator identifier, a computing resource identifier, etc.), (ii) a data type identifier, and data curation resource characteristics such as (iii) an efficiency score for the data type (e.g., an efficiency rate, or a duration of time required by the data curation resource to curate instances of the data type), (iv) an error rate for the data type (e.g., as curated by the data curation resource), (v) a quality score for historically curated data of the data type (e.g., historically curated data that was previously generated by the data curation process performed by the data curation resource), and/or (vi) other metrics of historical proficiency of the data curation resource (e.g., a level of proficiency of the data curation resource in curating data of the data type).

The efficiency score of the data type may indicate a rate at which the data curation resource has historically curated data of a data type. For example, the efficiency score may include number of curation targets labeled in a period of time by the data curation resource. A higher efficiency score (e.g., a higher number of curation targets per time period reflecting a higher level of efficiency) for a data type may indicate a higher level of proficiency of the data curation resource in curating data of the data type based on a rank ordering of efficiency scores for the data curation resources.

The error rate of curated data of the data type (e.g., curated by a data curation resource) may reflect a frequency of errors present in the curated data of the data type. For example, the error rate may include a mathematical comparison between a number of curation targets that were incorrectly labeled by the data curation resource and a total number of curation targets labeled by the data curation resource. A lower error rate for a data type (e.g., curated by the data curation resource) may indicate a higher level of proficiency of the data curation resource in curating data of the data type based on a rank ordering of error rates for the data curation resources.

The quality score for the historically curated data of the data type may measure the impact of the historically curated data on its downstream usability. The quality score may reflect, for example, (i) the efficacy of the data curation resource(s) (e.g., in producing desired and/or intended historically curated data), (ii) the efficacy of the historically curated data (e.g., in producing desired and/or intended results through the downstream use of the historically curated data), and/or (iii) the historically curated data and/or the usability (e.g., by downstream consumers) of the historically curated data (e.g., without further unanticipated manipulation and/or processing of the curated data). For example, the quality score may be based on feedback from downstream consumers and/or may reflect a measure of the quality of inferences generated by an inference model using the historically curated data as ingest data. A higher quality score for historically curated data of a data type (e.g., curated by a data curation resource) may indicate a higher level of proficiency of the data curation resource in curating data of the data type based on a rank ordering of quality scores for the data curation resources.

Data curation resource profile 206 may also include a level of proficiency (e.g., of a data curation resource) in curating one or more types of data. The level of proficiency of the data curation resource in curating data of a data type may be based on (e.g., may be a function of) at least one of and/or a combination of data curation resource characteristics (e.g., an efficiency score for the data type, an error rate for the data type, a quality score for the data type, and/or another measure of data curation resource ability). In other words, data curation resource profile 206 may reflect strengths and/or weaknesses of a data curation resource in curating one or more types of data.

Performance analysis process 204 may include obtaining, generating, and/or updating (e.g., when new historical data curation resource performance data becomes available) any number of data curation resource profiles, which may be stored in a repository and/or later accessed from the repository. For example, data curation resource profile 206 may be stored in data curation resource profile repository 208.

Data curation resource profile repository 208 may be managed by data manager 102 and/or by another entity (e.g., a third party). Any number of data curation resources profiles may be stored in data curation resource profile repository 208. The data curation resource profiles may be managed using a database, and may be accessed via a database query (e.g., based on data type). For example, the database may be queried by a data type when matching data curation resources with curation targets of the data type (e.g., in order to perform a data curation process for the curation targets using the matched data curation resource(s)).

Thus, as illustrated in FIG. 2A, the system of FIG. 1 may obtain and/or generate data curation resources profiles for data curation resources. The data curation resource profiles may reflect the proficiency of each data curation resources in performing data curation for data of one or more data types. The data curation resource profiles may be obtained prior to and/or may be used as part of the data curation process (e.g., to obtain a data curation assignment).

Turning to FIG. 2B, a data flow diagram is shown in accordance with an embodiment. The data flow diagram may illustrate a process for obtaining a data curation assignment in a system similar to that of FIG. 1. As discussed with respect to FIG. 1, data sources 100 may provide data for use by downstream consumers 104 in order to facilitate the provision of computer-implemented services. Before being provided to downstream consumers 104, the data (e.g., collected data) may undergo a data curation process. The data curation process may include collecting, organizing, and/or transforming the collected data into data usable by downstream consumers 104 using data curation resources.

Collected data obtained from data sources 100 may include any number of datasets collected from any number of data sources. Curation targets of the collected data may be identified prior to data characterization process 252 or as part of data characterization process 252. For example, the curation targets may be identified as part of a separate curation target identification process (not shown) and/or by a third party.

The curation targets may indicate portions of the collected data (e.g., one or more fields of one or more data points) that may benefit from data curation (e.g., metadata extraction and/or annotation) in order to be usable in downstream applications of the data. In other words, the identified curation targets may be the portions of data that are desired to be curated.

For example, continuing with the temperature measurements example, curation targets of the temperature data may include one or more field values, such as location field values (e.g., latitude and/or longitude of the position of a temperature sensor) and/or temperature field values (e.g., the recorded temperature value for a given time). The curation target may include information regarding a field, such as field types (e.g., a text string or a numerical value), field contents (e.g., a minimum or maximum number of characters per field), field units (e.g., degrees Celsius or degrees fahrenheit), etc. The curation targets may also include a subset of data points (of all data points of the collected data). For example, the curation targets may be all data collected from temperature sensors located in a specified geographical region.

Data characterization process 252 may include characterizing and/or classifying the identified curation targets, for example, by data type. The curation targets may be classified by data type based on one or more data characteristics of the collected data. The data characteristics may include a (i) subject of the data, (ii) a language of the data, (iii) whether the data includes images, unstructured text, etc., and/or (iv) any other characteristic useful for classifying data types. One or more and/or any combination of data characteristics of a curation target may be used to define the data type of the curation target.

The characterized curation targets may be assigned a data type, which may be stored as metadata of each curation target). The data type associated with a curation target may be multidimensional, and/or more than one data type may be assigned to a curation target. (e.g., for curation targets having multiple data characteristics). For example, a curation target may be assigned a data type (e.g., a multidimensional data type) indicating that the curation target includes textual data, and that the textual data is in multiple languages (e.g., the languages indicated by the data type).

Once the curation targets are characterized (e.g., assigned a data type), the characterized curation targets (along with their corresponding data type classifications) may be provided to curation target assignment process 254.

Curation target assignment process 254 may include obtaining the characterized curation targets (e.g., from data characterization process 252) and/or one or more data curation resource profiles (e.g., from data curation resource profile repository 208). As discussed with respect to FIG. 2A, a data curation resource profiles may include data curation resource characteristics of a data curation resource (e.g., for different data types) and/or may specify levels of proficiency of the data curation resource in curating the different data types.

Curation target assignment process 254 may include performing a data curation matching process. The data curation matching process may be performed based on the data types (e.g., the data types of the characterized curation targets and the data curation resource characteristics for the data types) to identify a match between one or more of the (characterized) curation targets and one or more data curation resources (e.g., 256A-256N). The match may include at least one matched curation target (e.g., the curation target) and at least one matched data curation resource.

To identify the match (e.g., the at least one matched data curation resource), a fitness value may be obtained for each of the data curation resources (e.g., 256A-256N). The fitness value may be derived using information from the data curation resource profiles (e.g., the data curation resource characteristics associated with the data type of the curation targets). The fitness value may indicate the level of proficiency of the data curation resource in curating the curation target. For example, a first data curation resource (e.g., data curation resource 256A) may be associated with a higher fitness value than a second data curation resource (e.g., data curation resource 256N), indicating that the first data curation resource may have a higher likelihood of curating the curation target more efficiently than the second data curation resource (e.g., and any other data curation resource with a lower fitness value).

The fitness values of each of the data curation resources may be used to define a rank ordering of the data curation resources. For example, a higher-ranked data curation resource may have a higher fitness value than a lower-ranked data curation resource. The rank ordering may be used to identify one or more data curation resources of the match. For example, the match may be identified based on a likelihood that the matched data curation resource will curate the matched curation target (e.g., the curation target) more efficiently than other data curation resources. The match may be used to obtain an assignment for data curation.

To do so, curation target assignment process 254 may include obtaining (e.g., from data curation resource manager 256) information regarding the availability of the data curation resources. The data curation resource availability information may include (i) a schedule of availability of one or more data curators (e.g., who may perform data curation), (ii) a schedule of availability of computing resources (e.g., usable for the data curation process), (iii) the available curation bandwidth of each of the scheduled data curation resources, and/or (iv) other metrics regarding data curation resources and their current and/or future availability (e.g., a current curation queue and/or backlog of a data curation resources). The data curation resource availability information may be analyzed and/or referred to as part of curation target assignment process 254 to obtain the availability of a data curation resource.

Curation target assignment process 254 may obtain an assignment for data curation. The assignment may include one or more data curation resources and one or more curation targets. The assignment may be based on (i) the match (e.g., one or more matched data curation resources and one or more matched curation targets), (ii) the availability of the matched data curation resources, (iii) a quantity of data curation resources needed to perform the data curation process for the matched curation targets (e.g., within a target period of time), and/or (iv) other factors.

For example, the match may include a rank-ordered list of matches. If the highest-ranked data curation resource (e.g., of the rank-ordered list of matches) is available for a period of time required to curate the curation target before a deadline, the assignment may include the highest-ranked (matched) data curation resource and the (matched) curation target. However, if the highest-ranked data curation resource is unavailable for the period of time required to curate the curation target before the deadline, then the assignment may include the second highest-ranked data curation resource and the curation target.

Once the assignment is obtained, assignment information may be provided to data curation resource manager 256, which may delegate curation responsibilities to one or more data curation resources (e.g., 206A-206N, based on the assignment information). The assignment information may include (i) a data curation resource identifier (e.g., assigned to and/or responsible for curating assigned curation targets), (ii) information regarding the assigned curation targets (e.g., a list of assigned curation targets, storage location(s) of the data to be curated, the curation target identifier and/or type), (iii) information regarding a time period for curation (e.g., deadlines), and/or (iv) other information used for assigning data curation workloads to data curation resources (e.g., priority levels of the assigned curation targets).

Data curation resource manager 256 may obtain and/or use the assignment information to identify one or more data curation resources (e.g., 256A-256N) responsible for performing the data curation process for the assigned curation targets. Data curation resource manager 256 may add the assigned curation targets to a position in a curation queue of the assigned data curation resource (e.g., based on the priority levels of the assigned curation targets and other curation targets already in the curation queue) and/or alert the data curation resource of an update to the curation queue. Data curation resource manager 256 may add any number of the assigned curation targets to the curation queues corresponding to any number of assigned data curation resources. Using the assigned data curation resources, the assigned curation targets may undergo data curation process 258.

Data curation process 258 may include performing data curation for each of the (assigned) curation targets (e.g., using the assigned data curation resources). Data curation process 258 may include data cleansing, organizing (e.g., structuring, indexing, cataloging), transforming, and/or any other process or method of data curation known in the art that may render the curation targets compliant with a schema for downstream use.

Data curation process 258 may include generating curated data 260. Curated data 260 may include one or more curation targets that have completed data curation process 258 (e.g., one or more curated portions of data). Curated data 260 may be provided for use by downstream consumers that may provide a computer-implemented service (e.g., using the one or more curated portions of the data).

As discussed with respect to FIG. 1, poorly allocated data curation resources (e.g., limited data curation resources) may result in unavailable and/or untrustworthy curated data for downstream use, which may adversely affect the provision of the desired computer-implemented services. Thus, as illustrated in FIG. 2B, the system of FIG. 1 may improve data curation resource allocation by matching data curation resources with curation targets based on the proficiency level of the data curation resources in curating the data type of the curation targets.

In an embodiment, the one or more entities performing the operations shown in FIGS. 2A-2B are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform methods for data curation by a data manager. The methods may include (i) matching data curation resources with curation targets, (ii) obtaining assignments (e.g., based on the match) that assign curation targets to data curation resources or vice versa, and/or (iii) performing data curation for the assigned curation targets by the assigned data curation resources to obtain curated data. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method for ranking curation targets in accordance with an embodiment is shown. The method may be performed by a data processing system, and/or another device. The following operations (e.g., 302 and 304) may be performed prior to performing a data curation process, and/or may be performed as preparation steps for performing a data curation matching process (discussed further in operation 352 of FIG. 3B).

At operation 302, historical data curation resource performance data may be obtained. The historical data curation resource performance data may be obtained by (i) reading the historical data curation resource performance data from storage, (ii) receiving the historical data curation resource performance data from a device (e.g., a third party and/or remote device) and/or (iii) generating the historical data curation resource performance data.

The historical data curation resource performance data may be generated, for example, by logging information (e.g., in real-time, by a data processing system) regarding the results and/or progress of a data curation resource that is performing a data curation process for a portion of data of a data type. The historical data curation resource performance data may also be generated, for example, by collecting, aggregating and/or storing human performance records created by the data curation resources (e.g., data curators) and/or managers thereof.

The logged and/or recorded information may include (i) durations of time required by the data curation resource to curate the portion of data, (ii) error rates for the data type of the curated data resulting from the data curation process as performed by the data curation resource, and/or (iii) other information regarding the past performance of the data curation resource when curating data of the data type. Refer to the discussion of FIG. 2A for more details regarding historical data curation resource performance data.

At operation 304, an analysis of the historical data curation resource performance data may be performed to obtain a data curation resource profile. The analysis of the historical data curation resource performance data may be performed, for example, by a third party (e.g., that offers data aggregation and analysis as a service) that may generate one or more data resource curation profiles. To obtain the one or more data resource curation profiles, the data curation resource profile may be received from the third-party service (e.g., from a remote device).

The analysis of the historical data curation resource performance data may also be performed, for example, by reading the historical data curation resource performance data (e.g., from storage) and/or aggregating portions of the historical data curation resource performance data (e.g., using one or more statistical methods) to obtain data curation resource characteristics. For example, the historical data curation resource performance may undergo statistical analysis (e.g., determining averages, medians, modes, etc. associated with each data type) to generate data curation resource characteristics of each data curation resource associated with one or more data types.

The data curation resource characteristics may include any statistical (e.g., numeric) representations of the past performance of one or more data curation resources (e.g., when curating one or more data types). For example, the data curation resource characteristics may include a data curation rate (e.g., for a data type), an error rate (e.g., for the data type), a quality score (e.g., for the data type), and/or a combination thereof.

As discussed with respect to FIG. 2A, a data curation resource profile may include data curation resource characteristics that may specify levels of proficiency of data curation resources (e.g., for different data types). The levels of proficiency may be based on one or more of the data curation resource characteristics.

The level of proficiency (e.g., of each data curation resource for curating different data types) may be obtained by evaluating a proficiency function. The proficiency function may be a function of variables (e.g., data curation resource characteristics and/or other variables). The variables may be weighted based on one or more objectives of the data curation process. For example, a single objective may be to curate as much data in as little time as possible, therefore the proficiency function may weight the data curation more heavily than the error rate and/or other variables of the function. Refer to the discussion of FIG. 2A for more details regarding data curation resource profiles.

The method may end following operation 304.

Using the methods illustrated in FIG. 3A, a system in accordance with embodiments disclosed herein may be placed in condition to analyze historical data curation resource performance data to obtain data curation resource profiles. The data curation resource profiles may be stored and/or later accessed for use as part of a data curation matching process that may improve the efficiency of the data curation process.

Turning to FIG. 3B, a flow diagram illustrating a method for curating data by a data manager in accordance with an embodiment is shown. The method may be performed by a data processing system, and/or another device.

At operation 352, a data curation matching process may be performed to identify a match between a portion of data and a data curation resource. The data curation matching process may be performed by (i) obtaining a characterized curation target of data intended for data curation (e.g., the curation target having been assigned one or more data types by a data characterization process as described with respect to FIG. 2B), (ii) obtaining a data curation resource profile (e.g., associated with a data curation resource, from a data curation resource profile repository), (iii) determining a fitness value for the data curation resource (e.g., based on the characterized curation target and the data curation resource profile), (iv) rank ordering the data curation resource (e.g., based on the fitness value), and/or (v) identifying the match (e.g., based in part, on the rank ordering).

The match (e.g., including a matched data curation resource and/or a matched data curation target). may be identified based on the likelihood that the matched data curation resource will curate the matched curation target(s) (e.g., portions of the data) more efficiently than other data curation resources.

To identify the likelihood, a data curation resource profile corresponding to the data curation resource may be obtained. The data curation resource profile may be obtained by (i) reading the data curation resource profile from storage (e.g., a data curation resource profile repository), (ii) receiving the data curation resource profile from a device (e.g., a third party and/or remote device) and/or (iii) generating the data curation resource profile (e.g., as discussed with respect to FIG. 3A).

As discussed, the data curation resource profile may include data curation resource characteristics indicating levels of proficiency (e.g., of the data curation resource) for curating different data types. To determine the relevant data curation resource characteristics (e.g., levels of proficiency), the data type of the curation target may be identified. The data type of the curation target may be identified by (i) obtaining the characterized curation targets (e.g., by reading the characterized curation target from storage), and/or (ii) reading metadata of the (characterized) curation target.

Based on the data type of the curation target, one or more data curation resource characteristics (e.g., levels of proficiency) may be obtained from the data curation resource profile and may be used as variables of a fitness function to determine the likelihood. For example, the likelihood may be represented by a fitness value. The fitness value for the data curation resource may be determined by evaluating the fitness function. The fitness function may include variables such as the data curation resource characteristics of the data curation resource (e.g., for the data type). Different fitness functions may be implemented and/or evaluated depending on the data type of the curation target.

Performing the data curation matching process may include determining fitness values for one or more data curation resources (e.g., the data curation resources being considered for the match). The fitness values may be used to rank order the data curation resource (e.g., the data curation resources being considered for the match). The rank ordering may represent the relative likelihood of each of the data curation resources curating the curation target (e.g., a portion of the data) more efficiently than the other data curation resources.

For example, the rank ordering may be defined by ordering (e.g., sorting) each of the data curation resources by descending fitness value and/or ranking (e.g., enumerating) the ordered data curation resources. For example, the data curation resource with the highest fitness value may be the highest ranked data curation resource.

The match (e.g., the matched data curation resource(s) of the match) may be identified by selecting one or more data curation resources (e.g., having the highest associated likelihoods) from the rank ordering of the data curation resources. For example, more than one data curation resource may be selected from the rank ordering to identify the match (e.g., the matched data curation resource of the match and/or an ordered list of matched data curation resources). The matching process may be performed for any number of data curation resources and/or (characterized) curation targets of a portion of data.

The data curation matching process may also be performed by a third party (e.g., as a service); therefore, the match may be identified by receiving the match (e.g., and/or the ordered list of matched data curation resources to the matched curation target) from the third party (e.g., from a remote device).

At operation 354, an assignment for data curation may be obtained, based at least in part, on the match. The assignment may be obtained by (i) reading the assignment from storage, (ii) receiving the assignment from a device (e.g., a third party and/or remote device) and/or (iii) generating the assignment.

The assignment may be generated, for example, by analyzing one or more of (i) the match (e.g., the matched data curation resource and/or the list of matched data curation resources), (ii) the availability of the matched data curation resource of the match (e.g., based on data curation resource availability information that obtained from a data curation resource manager), (iii) the matched curation target of the match (e.g. to determine a quantity of data curation resources needed to perform the data curation process for the matched curation target within a target period of time), and/or (iv) other factors affecting the data curation process (e.g., deadlines). The assignment may include one or more assigned curation targets (e.g., the matched curation target) and one or more assigned data curation resources (e.g., the matched data curation resource).

For example, the availability of one or more data curation resources (e.g., of the list of matched data curation resources) may be analyzed. The availability may be analyzed to determine which of the data curation resources have sufficient available bandwidth for performing a data curation process for the matched curation targets (e.g., in a period of time based on the required quantity of data curation resources and the deadline). Of the data curation resources with sufficient available bandwidth, one or more of the highest-ranked data curation resources (e.g., of the ordered list of matched data curation resources) may be included in the assignment.

At operation 356, a data curation process may be performed based on the assignment to obtain a curated portion of data by (i) transmitting assignment information (e.g., including the assignment) to a data curation resource manager and/or (ii) curating the assigned curation targets (e.g., using the assigned data curation resources). The assignment information may also be transmitted automatically by another entity (e.g., a third party). The data curation resource manager may use the assignment information to prioritize curation queues of one or more assigned data curation resources. For more information regarding assignment information, refer to the discussion of FIG. 2B.

The portion of data (e.g., one or more assigned curation targets) may be obtained from various data sources by reading the portion of the data from storage and/or receiving the portion of the data from another device managed by a data source. The portion of data from storage include unstructured and/or disorganized data, and therefore the usability (e.g., by downstream consumers) and/or trustworthiness of the data may increase after undergoing a data curation process. The data curation process may be performed using any software, method, and/or process familiar to those in the art.

Performing the data curation process may include transmitting a notification that newly assigned curation targets are available for curation (e.g., and that the data curation resources may begin a data curation process for the assigned curation targets).

Performing the data curation process may include transmitting instructions for data curation (e.g., including the assignment information) to another entity (e.g., a third party) who may perform the data curation process. One or more assigned curation targets may be curated by one or more assigned data curation resources. Further, the assigned curation targets may be curated in a specific order, such as by priority level (e.g., based on an ordered list of prioritized curation targets) in order to complete the data curation process within the target period of time using the assigned data curation resource.

Upon completion of the data curation process, a portion of curated data (e.g., curated curation targets of the data) may be obtained. The curated data may comply (e.g., the assigned curation targets comply) with a schema for downstream use and may therefore be trusted for downstream use (e.g., by downstream consumers). The downstream consumers may provide a computer-implemented service using the curated portion of the data.

For example, the downstream consumers may provide the computer-implemented service by (i) receiving the curated portion of the data, (ii) using the curated portion of the data as training data for training an inference model, and/or (iii) using the curated portion of the data as ingest data for generating inferences from the trained inference model. The computer-implemented services may include services provided by the trained inference model (e.g., image-labeling services for image data) and/or the inferences generated by the trained inference model (e.g., labels of ingested images of the image data).

The method may end following operation 356.

Using the methods illustrated in FIG. 3B, a system in accordance with embodiments disclosed herein may be placed in condition to identify a match between one or more data curation resource and data to be curated (e.g., based on the proficiency level of each data curation resource in curating data of different types). The matched data curation resource may be most likely to complete a data curation process more efficiently for data (e.g., of a data type) than other data curation resources within a period of time, thereby optimizing the allocation of data curation resources. Optimizing the allocation of data curation resources may improve the efficiency of and/or reduce the data resource curation costs of the data curation process. The resulting curated data may be more likely to be available to and/or trusted by downstream consumers than other curated data (e.g., curated by the other data curation resources that may be less proficient in curating the data).

By providing trustworthy curated data to downstream consumers, the computer-implemented services facilitated by the downstream consumers may be improved. For example, by ensuring curated data is available to downstream consumers, the likelihood of avoiding interruptions in and/or reductions in the quality of the computer-implemented services may be reduced.

Any of the components illustrated and/or described with respect to FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such, details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for curating data by a data manager, comprising:
performing a data curation matching process to identify a match between a portion of data and a data curation resource, the match being identified based on a likelihood that the data curation resource will curate the portion of the data more efficiently than other data curation resources;
obtaining, based at least in part on the match, an assignment for data curation; and
performing a data curation process based on the assignment to obtain a curated portion of data.

2. The method of claim 1, further comprising:
prior to performing the data curation matching process:
obtaining historical data curation resource performance data, and
performing an analysis of the historical data curation resource performance data to obtain a data curation resource profile.

3. The method of claim 2, wherein the data curation resource profile is used in the data curation matching process to identify the likelihood.

4. The method of claim 2, wherein the data curation resource profile specifies levels of proficiency of one of the data curation resources to curate different types of data.

5. The method of claim 4, wherein the historical data curation resource performance data comprises durations of time required by one of the data curation resources to curate instances of the different types of the data.

6. The method of claim 5, wherein the historical data curation resource performance data comprises error rates for the different types of the data in curated instances of the different types of the data as curated by the one of the data curation resources.

7. The method of claim 1, wherein performing the data curation matching process comprises:
rank ordering the data curation resources to curate the portion of the data to identify the data curation resource.

8. The method of claim 7, wherein rank ordering the data curation resources comprises:
obtaining a data curation resource profile for each of the data curation resources;
obtaining a data type for the portion of the data;
obtaining a fitness value for each of the data curation resources using a corresponding data curation profile and the data type; and
defining the rank ordering using the fitness value for each of the data curation resources.

9. The method of claim 8, wherein the data curation resource profile for each of the data curation resources comprises:
a level of proficiency for curating a type of the portion of the data.

10. The method of claim 9, wherein the level of proficiency is based on at least one selected from a group consisting of:
a data curation rate for the type of the portion of the data;
an error rate for the type of the portion of the data; and
a quality score for the type of the portion of the data.

11. The method of claim 1, further comprising:
providing a computer-implemented service using the curated portion of the data.

12. A non-transitory machine-readable medium having instructions stored therein, which when executed by a processor, cause the processor to perform operations for curating data by a data manager, the operations comprising:
performing a data curation matching process to identify a match between a portion of data and a data curation resource, the match being identified based on a likelihood that the data curation resource will curate the portion of the data more efficiently than other data curation resources;
obtaining, based at least in part on the match, an assignment for data curation; and
performing a data curation process based on the assignment to obtain a curated portion of data.

13. The non-transitory machine-readable medium of claim 12, the operations further comprising:
prior to performing the data curation matching process:
obtaining historical data curation resource performance data, and
performing an analysis of the historical data curation resource performance data to obtain a data curation resource profile.

14. The non-transitory machine-readable medium of claim 13, wherein the data curation resource profile is used in the data curation matching process to identify the likelihood.

15. The non-transitory machine-readable medium of claim 13, wherein the data curation resource profile specifies levels of proficiency of one of the data curation resources to curate different types of data.

16. The non-transitory machine-readable medium of claim 15, wherein the historical data curation resource performance data comprises durations of time required by one of the data curation resources to curate instances of the different types of the data.

17. A data processing system, comprising:
a processor; and
a memory coupled to the processor to store instructions, which when executed by the processor, cause the processor to perform operations for curating data by a data manager, the operations comprising:
performing a data curation matching process to identify a match between a portion of data and a data curation resource, the match being identified based on a likelihood that the data curation resource will curate the portion of the data more efficiently than other data curation resources,
obtaining, based at least in part on the match, an assignment for data curation, and
performing a data curation process based on the assignment to obtain a curated portion of data.

18. The data processing system of claim 17, the operations further comprising:
prior to performing the data curation matching process:
obtaining historical data curation resource performance data, and
performing an analysis of the historical data curation resource performance data to obtain a data curation resource profile.

19. The data processing system of claim 18, wherein the data curation resource profile is used in the data curation matching process to identify the likelihood.

20. The data processing system of claim 18, wherein the data curation resource profile specifies levels of proficiency of one of the data curation resources to curate different types of data.
